(19) United States
(12) Patent Application Publication
(10) Pub. No.: US 2005/0117645 A1
(43) Pub. Date: Jun. 2, 2005

(54) Coding video pictures in a pb frames mode

(76) Inventor: Jim Lin, Hsin Chu (TW)

Correspondence Address: PHILIPS INTELLECTUAL PROPERTY & STANDARDS, P.O. BOX 3001, BRIARCLIFF MANOR, NY, 10510, US

(21) Appl. No.: 10/502,152

(22) PCT Filed: Dec. 23, 2002
(86) PCT No.: PCT/IB02/05743

(30) Foreign Application Priority Data
Jan. 24, 2002 (EP) 02075296.0

(51) Int. Cl. H04N 7/12

(52) U.S. Cl. 375/240.16; 375/240.12; 375/240.24; 375/240.15

(57) ABSTRACT

A method of coding video pictures in a PB frames mode comprises the steps of: a) initializing a sum value; b) determining, for each block of a picture, a block motion vector, defining the block motion against the previous picture; c) computing a value indicating of the amount of each block motion vector and comparing each indicative value against a first predetermined threshold value; d) for each block motion vector, if the indicative value thereof exceeds said first predetermined threshold value, incrementing said sum value; e) if, after completing the comparison for all block motion vectors, said sum value exceeds a second predetermined threshold value, then; f) coding the video picture as comprising at least one P-picture, but no B-picture.

The invention relates to coding video pictures in a PB frames mode.

The ITU-T H.263 standard (ITU-T std. H.263-1995, published March 1996) provides as one of several different optional modes a PB frames mode which codes two pictures as one unit (Annex G). The term “PB” stems from P-picture and B-picture types. The PB-frame comprises one P-picture predicted from the previous decoded P-picture and one B-picture predicted from both the previous decoded P-picture and the P-picture currently being decoded. With this option, portions of the B-picture may be bi-directionally predicted from the past and future video pictures.

So, the PB frame contains an additional interpolated B-picture thereby temporally improving the decoded visual quality by increasing the frame rate. The benefit of a B-picture is that it results in less encoded bits than a pure P-picture. However, while applied to a video sequence containing larger block motions, e.g. quick moving objects, blurring and blocky artifacts will be obvious in an uncompensated B-picture, and thus, more bits are coded to compensate for the greater prediction error.

A further optional mode named Improved PB-frames mode (Annex M) is supported in Version 2 of recommendation H.263, which is informally known as H.263+. There are three different ways of coding B-macroblocks in the improved PB frames mode: forward, backward and bi-directional prediction. The three coding modes literally use the previously decoded P-picture, the P-picture currently being decoded, or both of them, respectively.

With the above additional prediction modes, the decision of either coding as a P-picture or PB frame in H.263 can be replaced by the decision of coding modes in H.263+, because the forward prediction mode is P-picture coding.

There are various trade-offs in selecting an optional mode provided by H.263. Because the modes are optional, it is not mandatory for a compliant decoder to support all of the optional modes. However, if a decoder supports a given mode, the encoder has the option to enable or disable that mode.

Currently, few methods exist for determining whether to enable or disable an optional mode for H.263 dynamically. Typically, an optional mode is enabled at the beginning of a video data sequence and stays on throughout the entire length of the video data sequence. The disadvantage of this method is that with some types of video, the optional mode results in decreased video quality. For other types of video, the increase in video quality does not justify the increase in computational overhead associated with the optional mode being enabled.

It is known to compute parameters for evaluating the coding error, for example the sum of prediction error of each macroblock, as disclosed in U.S. Pat. No. 5,870,148. These computations are quite processing-intensive.

Motion estimation is used by most current compressing schemes. In general, motion estimation can improve the prediction accuracy between adjacent pictures, and reduce bits required to code the prediction error.

A difficulty in motion compensated systems is handling scene changes. U.S. Pat. No. 5,218,435 features making a global decision as to whether to motion compensate a particular picture. The decision not to motion compensate is made when the different between the current and the previous picture is so great and so wide spread across the picture as to expect with a high degree of probability that a scene change has occurred. A single bit is preferably used to transmit this global decision to the decoder. Additional channel capacity is made available by not sending the motion vectors. It means on the other hand that to achieve a high degree of probability in the estimation, extensive computations have to be made.

However, if the predicting picture has low correlation with the previous reference picture, the motion vectors can form into a special pattern. This pattern, when detected, can be used as an indication of scene change.

With 3-DRS motion estimation, as described in G. De Haan, R. J. Schutten, “Real-time 2-3 pull-down elimination applying motion estimation/compression in a programmable device”, IEEE Int. Conf. on consumer electronics, June 1998, Los Angeles, most motion vectors of scene cut pictures are, experimentally, zero, while small portions of motion vectors, regularly less than 1%, are larger in magnitude.

It is the object of the invention to provide a method of coding video pictures in a PB frames mode without introducing too much computation overhead.

This object is solved by a method as defined in claim 1. Preferred embodiments are subject-matter of the subclaims.

According to the invention, a method of coding video pictures in a PB frames mode comprises the steps of:
initializing a sum value;
determining, for each block, a block motion vector, defining the block motion against the previous picture;
computing a value indicative of the amount of each block motion vector and comparing each such value against a first predetermined threshold value;
for each block motion vector, if the indicative value thereof exceeds said predetermined threshold value, incrementing said sum value;
if, after completing the comparison for all block motion vectors, said sum value exceeds a second predetermined threshold value then
coding the video picture as comprising at least one P-picture, but no B-picture.

Basically, in case that the above criteria are fulfilled, it is possible to encode one single P-picture. It may be more homogeneous to encode a PP-picture instead, so that all pictures will be in PB frame form, but have two different kinds of bit allocation. If there is large block motion, the above strategy will result in a PP-picture, where the prediction error is in encoded, if there is small block motion, a PB-picture will be achieved, without prediction error encoded.

If the above condition that said sum value exceeds a second predetermined threshold value is not fulfilled, then the picture may be encoded as comprising a B-picture.

The indicative value may be the absolute value of a block motion vector. The indicative value may also be the x- or y-component of a block motion vector. It may be appropriate to repeat the method described above, using different indicative values. This will lead to an efficient handling of scene cuts, as will be explained further below.

It is within the scope of the invention that the relations of the various parameters used in the method of the invention could be chosen such that the decisive criterion is that a threshold value is not reached instead of exceeding it.

The above coding scene can preferably be used in operating multi-media devices, in particular cellular phones with video facilities, personal computers with video cameras, information technology terminals, where also video information must be available, portable cameras, digital video recorders and the like.

Further, the invention can be realized by a computer program product, having thereon computer program code means, when said program is loaded, to make the computer execute procedure to code video pictures in a PB frames mode, wherein the procedure comprises the steps of the above described method.

In the following, the invention will be described with reference to the annexed drawings and figures, wherein

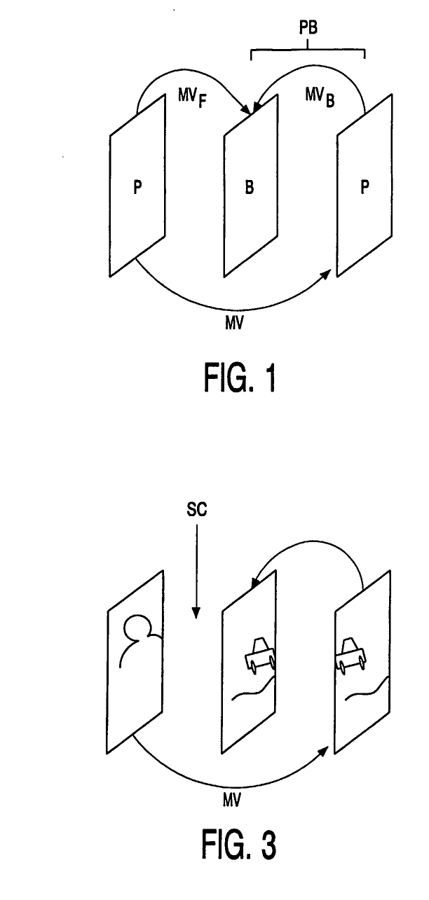

FIG. 1 is a schematic illustration of a PB-frame in the H.263 standard;

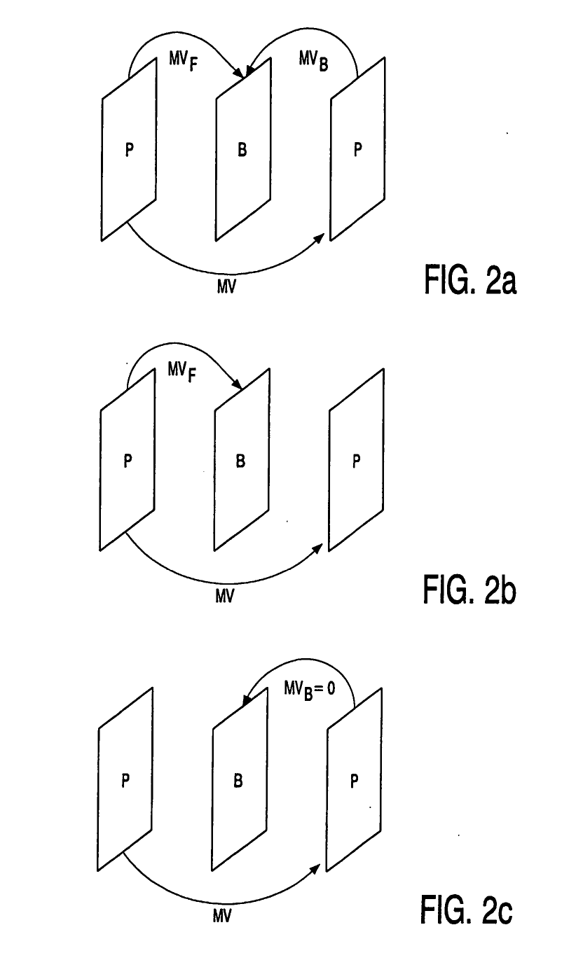

FIG. 2 an illustration of the three B-macroblock coding modes in Annex M of H.263+, FIG. 2(a) illustrating the bi-directional prediction, FIG. 2(b) forward prediction and FIG. 2(c) backward prediction; and

FIG. 3 the coding mode when scene cut is detected.

FIG. 1 illustrates the PB frames mode in the H.263 standard. The forward and backward motion vectors for a B-picture, MV_{F} and MV_{B}, are linearly scaled from the motion vector MV of the P-picture of a PB frame. Then, a delta motion vector can be coded to fine-tune MV_{F}, and MV_{B} is adjusted accordingly, where MV_{B}=MV_{F}−MV. The benefit of the interpolated B-picture, however, can only be used fully when applied to a video sequence without larger block motions. The problems occurring when consequential pictures with larger motion are coded in PB frames mode are overlaying of the pictures. Pictures with scene change show up similar problems. Therefore, there must be motion compensation.

FIG. 2 illustrates the three B-macroblock coding modes in Annex M of H.263+.

The three coding modes are
1. forward prediction: coding the forward motion vector of a B-picture of PB frame;
2. backward prediction: coding no motion vector, said prediction of the B-picture of PB frame identical to P-picture of PB frame; and
3. bi-directional prediction: assigning forward and backward motion vectors by scaling the motion vector of P-picture of PB frame, with the absence of delta motion vector for the forward motion vector.

Compared with Annex G of H.263, Annex M of H.263+ is extended in prediction direction choice, but simplified in the modification of MV_{F}, since there is no delta included in the bi-directional prediction.

The following table 1 lists priorities from high to low both versions of H.263 coding sequences.

TABLE 1

| Coding | | |
|---|---|---|
| sequence | Adopted mode | Condition |
| H.263 | PB frame | Majority of zero motion vectors |
| | P picture | Majority of non-zero motion vectors |
| H.263+ | Backward | Massive majority of zero motion vectors |
| | | with spikes |
| | bi-directional | Majority of zero motion vectors |
| | Forward | Majority of non-zero motion vectors |

Apparently, H. 263 is a subset of H.263+, and the coding mode decision of H.263 can be a simplified version of H.263+. Therefore, the strategies for PB frame and P-picture of H.263 sequences can be met to the ones for bi-directional prediction and forward prediction of H.263+ sequences, respectively.

The main operations of the invention are the following:
to decide whether to code as a P-picture or PP-picture or as a PB-picture or a PB-frame in H.263 sequences;
to determine the coding mode of Annex M in H.263+ sequences.

Normally, “large motion” will mean that about 20 to 100% or preferably about 40 to 100% of the motion vectors have a non-zero absolute value. These proportions would define a first threshold value if the indicative value “absolute value” is used to determine the type of the picture. If such threshold values are not met, a scene cut could be present.

It is assumed that a scene cut sc happened between a first picture and a second picture. Therefore, these two pictures are of low correlation, so that almost all motion vectors are zero in 3 DRS. By applying the method of the invention it can be determined, for example, that only about 20% of the motion vectors have a non-zero absolute value. In other words, a majority of the motion vectors, in the example about 80%, have an absolute value of zero. Further, there are still spikes, wherein a spike is a motion vector whose x- or y-component is greater than 5 pixels, which is based on experimental results. These spikes can also be used as indicators for scene changes, so that the indicative value which will be compared against a first threshold value will be the x- or y-component with a threshold value of, for example, 5 pixels. The number of motion vectors whose x- or y-component exceeds said first threshold value will be counted or summed up, and then compared against a second threshold value, for example, a proportion of motion vectors in which the spikes exist, for example in 10% of the motion vectors. Should spikes exist in more than about 10% of motion vectors, the pictures would not qualify to describe a scene cut.

If a scene cut sc happens between the previous reference P-picture and B-picture of a PB frame, there is an obvious benefit to set the current PB frame to be coded as backward prediction. That is, because the backward prediction results in less prediction error of a B-picture, thereby reducing compensating bits. This is shown in FIG. 3.

Since the characteristics of the test sequences differs, a parameter sequence entropy is introduced to reflect randomness, or information capacity, of each sequence. Going to the DPCM structure of H.263, it is reasonable to include entropy of an I picture and entropy of picture differences into information capacity of the sequence. Thus, sequence entropy is defined as average of some of the entropy of the I picture (the first picture of each sequence), and the average entropy of all picture differences, i.e.

$$Sequence entropy ≡ \frac{1}{2} ( entropy of {picture}_{0} + \frac{1}{N - 1} {\sum }_{i = 1}^{N - 1} entropy of ( {picture}_{i} - {picture}_{i - 1} ) )$$

in equation (1), N pictures are contained in the test sequence and the ith picture is denoted by pictureᵢ, where i ε[O, N−1].

To evaluate the performance of the three coding modes on different types of video, a parameter gain is introduced which is defined as

$$gain ≡ average PSNR of B pictures \cdot \frac{sequence entropy}{bit rate}$$

The parameter gain is a scaled PSNR of B-pictures of PB frames and is sufficient to reflect compression performance with considering visual quality (average PSNR of B pictures) and compression ratio (sequence entropy/bit rate). The gain of the three coding modes for various sequences has been evaluated.

Bi-directional prediction has advantage in sequences of moving minority in which most blocks are background without changes, and forward prediction has advantage in sequences of moving majority in which most blocks are for ground with changes. Large motion vectors tend to make imprecise predictions, and more compensating bits are needed.

Backward prediction does not show its advantage in any sequence. However, it helps to reduce coded bits when a scene cut happens between previous reference P-picture and B-picture of a PB frame.

According to the invention, the coding mode decision is as follows:
1. perform macroblock-based motion estimation of the picture being coded
2. decide prediction mode
   I. Set backward prediction when scene cut is detected between the previous reference P-picture and B-picture of a PB frame, for example if over 80% of motion vectors have an absolute value of zero, and motion vector spikes exist in less than 10% of motion vectors;
   II. Set bi-directional prediction if a majority, e.g. 70%, of motion vectors have an absolute value of zero;
   III. Otherwise, set forward prediction.
3. Resume procession according to the chosen prediction mode.

### EXAMPLE

The coding mode decision strategy according to the invention has been applied to several video sequences, all with the same fixed quantizer and fixed frame rate. It may be concluded that in most cases of typical video conferences and TV commercials advantage can be taken from the invention.

The features disclosed in the foregoing description, in the claims and/or in the accompanying drawings may, both separately and in any combination thereof, be material for realising the invention in diverse forms thereof. The invention is advantageously implemented by means of a processor that carries out the above-described method.

1. A method of coding video pictures in a PB frames mode, comprising the steps of:
a) initializing a sum value;
b) determining, for each block of a picture, a block motion vector, defining the block motion against the previous picture;
c) computing a value indicating of the amount of each block motion vector and comparing each indicative value against a first predetermined threshold value;
d) for each block motion vector, if the indicative value thereof exceeds said first predetermined threshold value, incrementing said sum value;
e) if, after completing the comparison for all block motion vectors, said sum value exceeds a second predetermined threshold value, then
f) coding the video picture as comprising at least one P-picture, but no B-picture, else coding the picture as comprising a B-picture.

2. The method of claim 1, wherein, if said sum value does not exceed said second threshold value, the picture is encoded as comprising a B-picture.

3. The method of claim 1, wherein if said sum value does not exceed said second threshold value, steps a) to e) are repeated using a different indicative value and optionally different first and second threshold values.

4. The method of claim 1, wherein said indicative value is the absolute value of a block motion vector.

5. The method of claim 1, wherein said indicative value is the x- or y-component of a block motion vector.

6. Use of a method according to claim 1 in operating multi-media devices, in particular cellular phones with video facilities, personal computers with video cameras, information technology terminals, portable cameras, digital video recorders.

7. A computer program product, comprising a computer program code means, when said program is loaded, to make the computer executed procedure to code video pictures in a PB frames mode, comprising the steps of:
a) initializing a sum value;
b) determining, for each block of a picture, a block motion vector, defining the block motion against the previous picture;
c) computing a value indicating of the amount of each block motion vector and comparing each indicative value against a first predetermined threshold value;
d) for each block motion vector, if the indicative value thereof exceeds said first predetermined threshold value, incrementing said sum value;
e) if, after completing the comparison for all block motion vectors, said sum value exceeds a second predetermined threshold value, then
f) coding the video picture as comprising at least one P-picture, but no B-picture, else coding the picture as comprising a B-picture.

8. The computer program product of claim 7, wherein, if said sum value does not exceed said second threshold value, the picture is encoded as comprising a B-picture.

9. The computer program product of claim 7, wherein if said sum value does not exceed said second threshold value, steps a) to e) are repeated using a different indicative value and optionally different first and second threshold values.

10. The computer program product of claim 7, wherein said indicative value is the absolute value of a block motion vector.

11. The computer program product of claim 7, wherein said indicative value is the x- or y-component of a block motion vector.

12. An apparatus for coding video pictures in a PB frames mode, comprising a processor for carrying out the method of claim 1.
